(19) United States
(12) Patent Application Publication
(10) Pub. No.: US 2017/0257671 A1
(43) Pub. Date: Sep. 7, 2017

(54) TRACKING-BASED BRANCHING OF MEDIA CONTENT

(71) Applicant: Calay Venture S.à r.l., Bettembourg (LU)

(72) Inventor: Cevat Yerli, Frankfurt am Main (DE)

(73) Assignee: Calay Venture S.à r.l., Bettembourg (LU)

(21) Appl. No.: 15/059,128

(22) Filed: Mar. 2, 2016

(51) Int. Cl. H04N 21/442; H04N 21/41; H04N 21/466; H04N 21/4415

(52) U.S. Cl. CPC H04N 21/44222; H04N 21/4415; H04N 21/4104; H04N 21/4668

(57) ABSTRACT

A method for controlling media content and an apparatus are described. The method comprises providing media content including a plurality of virtual objects and a plurality of triggers, each of the triggers being associated with at least one of the virtual objects; presenting the media content to a plurality of viewers; continuously receiving tracking data of the viewers, matching the tracking data to the triggers; if the tracking data matches at least one trigger, branching the media content into a plurality of branches including a main branch and at least one auxiliary branch, each auxiliary branch associated with at least one viewer; for each matched trigger, automatically adjusting the virtual object(s) associated with the matched trigger in the corresponding auxiliary branch, simultaneously presenting the branches of the media content to respective viewers, and joining the auxiliary branch(es) with the main branch.

### TECHNICAL FIELD

The disclosure relates to control of media content based on tracking data related to a plurality of viewers of the media content. In particular, the present disclosure may relate to gaze-based interaction with media content.

### BACKGROUND

In present systems, media content is typically presented to a viewer in a linear way, wherein the viewer may watch a linear story from a start point to an end point. The viewer may control replay of the media by, for example, starting, pausing and stopping the replay or by selecting a particular point in time in the linear story of the media content to initiate replay.

More recently, non-linear media has been proposed, allowing a viewer to influence the progress of a non-linear story, for example, by explicitly providing input which selects an option for the future story line. However, these systems require an explicit input of the viewer at particular points in time, which may disturb a fluent perception of the media content. Furthermore, viewers of the media content are limited to the options that are explicitly defined for the media content.

Non-linear media may be presented to several viewers. If one of the viewers changes the progress of the story line, the same output is presented to all of the viewers.

Therefore, one object of the present disclosure is to provide an integrated and more flexible approach for media control for a plurality of viewers.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The above problem is solved by a method for controlling media and an apparatus according to embodiments disclosed herein.

According to one aspect of the present disclosure, a method for controlling media is provided, which comprises providing media content including a plurality of virtual objects and a plurality of triggers. Each of said plurality of triggers is associated with at least one virtual object of the plurality of virtual objects. The method further comprises the steps of presenting the media content to a plurality of viewers; continuously receiving tracking data of the plurality of viewers; matching the tracking data to the plurality of triggers; and, if the tracking data matches at least one trigger, branching the media content into a plurality of branches including a main branch and at least one auxiliary branches, each auxiliary branch associated with at least one viewer. For each matched trigger, the at least one virtual object associated with the matched trigger is automatically adjusted in the corresponding auxiliary branch. The plurality of branches of the media content are simultaneously presented to respective viewers of the plurality of viewers, and the at least one auxiliary branch is joined with the main branch.

The media content may be any kind of media, such as audio, video and multimedia. Preferably, the media content may be immersive media content that may be provided to a viewer in an immersive way. An immersive display of media content may include rendering of the media content according to various modalities, such as visual, acoustic, haptic, gustatoric or olfactoric modality, in a way that resembles a natural perception of the real environment by corresponding organs. For example, a visual component of the immersive media content may be rendered in a stereoscopic way by providing separate images for the left and the right eye of the viewer. Similarly, an acoustic component may be rendered using binaural acoustics or any other technology providing location-oriented perception of sound. However, it is to be understood that even though the media content may be provided to the viewer in an immersive way, the media content may also be rendered on legacy output devices such as on a non-stereoscopic display or using a standard mono or stereo output with existing loudspeakers.

The media content may include one or more components for respective modalities in any combination. For example, the media content may include a visual or an acoustic component only. However, the media content may include an acoustic, a visual and a haptic component that may be provided to the viewer in any combination.

The media content may define a plurality of virtual objects and may define a story, which is directed at an evolution of the plurality of virtual objects. For example, the virtual objects may represent characters and items of the media content that may develop during presentation of a linear or non-linear story as defined by the media content.

The plurality of triggers of the media content may represent a functional component of the media content that is associated with at least one virtual object of the media content and which may influence the evolution of the associated virtual objects. Each trigger may influence a single virtual object of the media content. However, it is to be understood that the trigger may also influence a set of one or more virtual objects and the number of virtual objects in the set may change during progression of the linear or non-linear story of the media content. Hence, evolution of the virtual objects may be adjusted according to the story line and may further be implicitly influenced via associated triggers.

Tracking data as used throughout this disclosure may relate to sensor data obtained by a tracker that are related to the plurality of viewers. For example, the tracking data may relate to visual tracking in order to determine at least one position and orientation of body parts of one or more viewers, which may be, for example, obtained using a stereoscopic or depth camera or a similar optical tracking system. The tracking data may also relate to physiological sensor data related to, for example, the heart rate of a viewer or skin resistance, as well as acoustic data and the like. Preferably, the tracking data may be related to a position and orientation of the head or of the eyes of a viewer in order to determine the viewer's gaze. The tracking data may include a set of tracking data samples, wherein each tracking data sample may be related to a viewer of the plurality of viewers. Each tracking data sample may include an indication of the related viewer. Parts of the tracking data may be initially related to at least some of the plurality of viewers. For example, an optical tracking system may capture tracking data that may be related to a plurality of viewers positioned in front of the optical tracking system. The tracking data may be further processed and analyzed in order to distinguish each individual viewer and to relate respective tracking data samples with individual viewers. The tracking data may be raw tracking data defining the original sensor data, such as a series of images or a series of measurements. The raw tracking data may be further processed in order to derive parameters related to individual viewers. However, raw tracking data may be pre-processed by the tracker and the tracking data may directly define the parameters of individual viewers. The tracking data may be continuously received in order to enable a continuous monitoring of parameters of the plurality of viewers. For example, the tracking data may be received according to predefined time intervals or responsive to a change of parameters represented by the tracking data. A continuous reception of tracking data enables a continuous monitoring of the parameters of the plurality of viewers in order to enable a seamless adjustment of virtual objects based on current and/or previous tracking data in respective branches of the media content.

The received tracking data are matched to triggers of the media content. For example, the matching may determine whether parameters of the viewer that may be represented by a portion of the tracking data, such as a tracking data sample, correspond to parameters of a trigger. If the portion of tracking data matches (the parameters of) the trigger, the associated virtual objects are automatically adjusted in respective branches of the media content. Preferably, the virtual objects associated with the trigger are automatically adjusted according to the portion of the tracking data, for example, by taking into consideration the parameters of the viewer that are represented by the portion of the tracking data.

The tracking data may also include tracking data for at least some of the plurality of viewers, which may be matched to the plurality of triggers or respective parameters.

For example, a first portion of the tracking data (a first tracking data sample) related to a first viewer may match a first trigger and a second portion of the tracking data (a second tracking data sample) related to a second viewer may match a second trigger. Furthermore, a portion of the tracking data related to a viewer may match a plurality of triggers or respective parameters. For each viewer associated with a portion of the tracking data matching at least one trigger, an auxiliary branch of the media content may be branched off the main branch of the media content and the at least one virtual object associated with the matched trigger is automatically adjusted in the respective auxiliary branch. Hence, a viewer generating tracking data that match a particular trigger may implicitly influence the story line of the media content in the respective branch. If a group of viewers generate tracking data that matches the same trigger, the group of viewers may be associated with a single auxiliary branch. Accordingly, each viewer of the plurality of viewers is either presented with an auxiliary branch of the media content if its tracking data matched a trigger or with the main branch of the media content if its tracking data did not match any of the triggers. The plurality of branches of the media content are presented simultaneously to the plurality of viewers. Hence, each viewer may experience an implicit adjustment of the media content based on his tracking data individually, however, simultaneously with the other viewers of the media content. Each auxiliary branch may simultaneously or subsequently be joined with the main branch such that all of the plurality of viewers may eventually return to a joined experience of the media content.

Preferably, based on the continuously received tracking data, further auxiliary branches may be branched off the main branch and again be joined back according to a matching of the tracking data with the plurality of triggers of the media content.

The method for controlling media enables an implicit interaction of a plurality of viewers with the media content which results in a temporarily individualized experience of the media content. Hence, the approach according to the present disclosure does not require an explicit interaction, for example, requiring a selection of particular options or providing an explicit input. Rather, the viewers may observe the media content and responsive to tracked behavior of the viewers, virtual objects associated with respective triggers are automatically and implicitly adjusted for the viewers in respective branches. This leads to a perception of the media content in a way which is not disturbed by explicit interaction. The perception of the media content is also highly individualized for each viewer. Yet, a social experience of the media content is not disturbed since the branches of the media content are again joined back into a single branch. This leads to a social, yet individualized provision of media content for a group of viewers. Furthermore, by providing individual triggers in the media content, the story line of the media content can be flexibly drafted without particular restrictions directed at input at selected points in time.

In an embodiment, at least one viewer related to the tracking data matching a trigger is determined, the at least one viewer is associated with a corresponding auxiliary branch, and the corresponding auxiliary branch is simultaneously presented to the associated at least one viewer. Each portion of the tracking data may include an indication identifying one or more of the plurality of viewers that are represented by the tracking data. If the tracking data matches a trigger, the indication may be used to associate the one or more viewers with the corresponding auxiliary branch for simultaneous presentation of the auxiliary branch to the one or more viewers. The corresponding matching of the viewers to individual auxiliary branches may be determined as soon as a portion of the tracking data, such as a tracking data sample, matches a trigger. Hence, one or more viewers associated with the same portion of tracking data may be associated with the same auxiliary branch of the media content. If a single viewer is associated with several portions of the tracking data which, however, relate to different groups of viewers, a further auxiliary branch may be branched off the main branch and presented to the single viewer or to a plurality of viewers of an intersection of both groups of viewers.

In yet another embodiment, the main branch of the media content is simultaneously presented to at least some of the remaining viewers. The remaining viewers may be one or more viewers of the plurality of viewers that have not generated tracking data at all or that have not generated tracking data matching at least one trigger. The main branch of the media content may develop according to a story line of the media content, however, without any further adjustment of virtual objects based on tracking data. Since the tracking data is continuously received, it is to be understood that even during simultaneous presentation of the main branch with one or more auxiliary branches, a trigger may be matched according to current tracking data of the remaining viewers, which may result in branching off a further auxiliary branch for respective viewers which may be, thereafter, removed from the group of remaining viewers and simultaneously provided with the further auxiliary branch of the media content.

According to another embodiment, the at least one auxiliary branch is joined with the main branch according to at least one condition. Preferably, the at least one condition may be a time-based condition. Additionally or as an alternative, the at least one condition may further define a relation of the virtual objects in the auxiliary branch and/or in the main branch, preferably with respect to each other. For example, a matched trigger may result in a particular adjustment of a virtual object in an auxiliary branch and the virtual object may return to an initial state if the tracking data of the viewer do not match with the trigger anymore. Thereafter, the auxiliary branch may be joined with the main branch. However, the auxiliary branch may also be joined with the main branch after a predetermined period of time or after expiry of a timer which may, however, be reset in the auxiliary branch if the tracking data again match the trigger. Similarly, each auxiliary branch may be presented for a predetermined period of time irrespective of matching of tracking data with the trigger during presentation of the auxiliary branch. This may allow for a seamless joining of the individualized auxiliary branches with the main branch according to conditions and enables an individual response of the media content to tracking data of viewers which, however, returns back to the main branch and, therefore, preserves a social experience of the media content.

In yet another embodiment, said joining includes continuously transforming the adjusted at least one virtual object in the at least one auxiliary branch according to corresponding virtual objects in the main branch. For example, the parameters of the virtual objects in the auxiliary branch may be compared to parameters of the virtual objects in the main branch and the individual parameters of the virtual objects in the auxiliary branch may be continuously transformed into current parameters of the corresponding virtual objects in the main branch. Other interpolation, morphing or transformation approaches may be used to smoothly transform the virtual object of the auxiliary branch into a corresponding virtual object in the main branch. As soon as the virtual objects of the auxiliary branch match the virtual objects of the main branch, the presentation of the auxiliary branch may be switched to the presentation of the main branch and the auxiliary branch may be deleted.

In yet another embodiment, said branching includes creating one or more instances of at least some of the plurality of virtual objects for each auxiliary branch. The instances may be created for the virtual objects associated with the matched trigger, which will be affected by the tracking data. Preferably, said branching may include creating one or more references for at least some of the plurality of virtual objects for each auxiliary branch, the references referring to corresponding virtual objects in the main branch. This may greatly reduce complexity of the branching of the media content since the media content does not need to be replicated in each individual branch. Rather, the branches may only include instances of those virtual objects that are automatically adjusted according to the matched triggers and tracking parameters. Any further virtual objects of the auxiliary branch may be addressed using corresponding references to virtual objects in the main branch.

Preferably, said processing of an auxiliary branch includes processing the media content in the auxiliary branch according to the one or more instances of virtual objects in the auxiliary branch and one or more references to virtual objects in the main branch. It is to be understood that according to a particular simulation of the virtual objects in an auxiliary branch, it may become necessary to convert a reference to a virtual object into an instance of the virtual object if a virtual object of the auxiliary branch affects the virtual object that is represented by a reference. Furthermore, according to a storage complexity of the virtual objects of the media content, the media content may be completely replicated in at least some of the auxiliary branches, for example, by creating instances of each virtual object of the media content based on a determination of an overhead of processing of references and the complexity of the replications of the media content in each auxiliary branch. Hence, the story line of the media content in each auxiliary branch and in the main branch may be influenced by tracking parameters of respective viewers individually, thereby creating a temporal individualized experience of the media content for the plurality of viewers.

In an embodiment, the media content is presented in a virtual environment. Virtual environments are known from virtual reality, augmented reality or mixed reality technology and define a spatial and temporal environment for presentation of (immersive) media content. For example, the virtual environment may enable a definition of positions and orientations of virtual objects of the media content and may simulate a behavior of the virtual objects, for example, by simulating physical and mechanical properties of the virtual objects, by providing collision detection in the virtual environment, and the like. For example, the virtual environment may be enabled using a game engine and the virtual objects of the media content may be embedded within the virtual environment. Hence, the media content may define the virtual objects and a particular behavior and evolution of the virtual objects over time. Additionally or as an alternative, the media content may only define an initial configuration of the virtual objects and the evolution of the virtual objects over time may be influenced by the game engine driving the virtual environment. The virtual environment may be provided to the plurality of viewers using immersive technology, such as using immersive displays, see-through displays or stereoscopic displays, corresponding loudspeaker arrays, force feedback devices and/or devices for olfactoric or gustatoric output, and the like, in any combination. For example, one or more individual components of the immersive media content may be provided to respective output devices rendering the modality represented by the component. If a plurality of displays, such as head-mounted displays, is used for each individual viewer of the plurality of viewers, the media content may be individually provided to the viewers according to a corresponding auxiliary branch or the main branch simultaneously. Furthermore, if a single display is used, each individual user may wear glasses, such as shutter glasses or glasses with polarization filters, which may enable a splitting of the shown media content for the individual viewers.

In yet another embodiment, said matching the tracking data to the plurality of triggers includes determining whether, based on the tracking data, a viewing direction of a viewer corresponds to the at least one trigger. The tracking data may either directly represent the viewing direction or may be processed to determine the viewing direction of the viewer. As used throughout this disclosure, the terms viewing direction or gaze may be used interchangeably. The viewing direction may be determined on several granularities. For example, at a coarse level, the viewing direction may correspond to an average body orientation of the viewer. On a finer level, the viewing direction may correspond to an orientation of the viewer's head. On yet another finer level, the viewing direction may correspond to the direction of the eyes of the viewer. Furthermore, the viewing direction may include two components directed at a viewing direction of the left eye and the right eye of the viewer. The viewing direction at any level of granularity may be matched to parameters as defined by the trigger in order to determine whether the viewing direction matches the trigger. If several levels of granularity of viewing direction are used, the processing may start with a viewing direction at the coarsest level in order to determine a suitable trigger. The matching may be refined on each level in order to determine a matching trigger. However, it is to be understood that parameters of the tracking data need not be exactly matched on corresponding parameters of the trigger, for example, by determining whether parameters of the tracking data fall into a range defined by parameters of the trigger. Rather, matching of the tracking data to the at least one trigger may also result in a continuous value which may indicate a confidence of the matching. For example, a parameter of the tracking data falling within a range as defined by the trigger may indicate a perfect match, which may be, for example, represented by a value of 1.0. However, if the parameter of the tracking data does not fall into the range, the distance of the parameter to one of the boundaries may be used to calculate a value in the range of 0.1 or a value in any other suitable range. The confidence value may be used as a weighting factor during adjustment of the at least one virtual object associated with the at least one trigger based on the matching.

In a further embodiment, said matching the tracking data to the plurality of triggers includes determining whether the viewing direction corresponds to an area associated with at least one trigger, wherein the area is defined based on the at least one virtual object associated with the at least one trigger. For example, the area may correspond to a bounding box of the virtual object or to a sphere around a central or a point of interest associated with the virtual object. The trigger may also be associated with a plurality of virtual objects and the area may represent a union of bounding boxes of the individual virtual objects or any other two-dimensional or three-dimensional area associated with the virtual objects. The area may correspond to a position and orientation as well as dimensions of the virtual objects in the virtual environment. However, the area could also be linked to any other object or item of the media content which may be related to the virtual object. For example, the virtual objects may be contained in another virtual object, that may correspond to a container or the like. The trigger associated with a virtual object in the container may be linked to an area of the container.

The determination of a correspondence of the viewing direction with the area may be based on a determination of an intersection of a line with a plane or surface as defined by the viewing direction and the area, respectively. If the line intersects the plane or surface, a full match may be determined. If the line passes the plane or surface, a minimum distance can be used to determine a confidence value.

In one embodiment, the tracking data is indicative of a position and orientation of a viewer that may, preferably, correspond to a position of a head of the viewer and to a viewing direction, respectively. Said matching may be based on a line defined by the head position and the viewing direction. Accordingly, the area may define a plane with boundaries or a plurality of surfaces that may be used to determine an intersection of the line with the area.

In yet another embodiment, at least some of the virtual objects include a set of parameters for determining behavior of the virtual objects in the immersive media content and the set of parameters is automatically adjusted responsive to said matching. The set of parameters may, for example, define one or more of a position or orientation of the virtual object, material properties and/or any other physical properties of the virtual object. The set of parameters may also include one or more links to other virtual objects of the immersive media content that may be used to influence the behavior of the other virtual objects. Responsive to matching of the tracking data to the trigger, at least one parameter of the set of parameters may be automatically adjusted. For example, a position and orientation of the virtual object may be changed based on a viewing direction of a viewer.

Preferably, the position and orientation of the virtual object is automatically adjusted based on the tracking data, including the viewing direction. Hence, the viewing direction or the viewer's gaze may implicitly influence the evolution of the virtual objects in the media content in a respective auxiliary branch.

In an embodiment, for a matched trigger, a further virtual object is inserted into the media content in the respective auxiliary branch. Accordingly, an implicit interaction of a viewer with a virtual object, as determined by a matching of the tracking data with at least one trigger associated with the virtual object, may result in generation and insertion of further virtual objects into the media content in an auxiliary branch. This may correspond to creation of new virtual objects in the media content or an introduction of new virtual objects into the media content responsive to an implicit reaction of the viewer to a current evolution of the virtual objects. Preferably, said joining includes removing the further virtual object from the immersive media content in the respective auxiliary branch. The further virtual object may be smoothly blended out in order to allow for a seamless transition from the auxiliary branch to the main branch. The blending may include a decrease of opacity of the further virtual object and/or an adjustment of position and orientation of the further virtual object. It is to be understood that any other technique suitable for seamless removal of virtual objects from media content may be applied.

According to yet another embodiment, for a matched trigger, one of the plurality of virtual objects is removed from the media content in the respective auxiliary branch. The tracking data can be used to influence progression of a story of the media content which is, however, implicit and does not require any explicit input from the viewer. Viewers also need not be explicitly notified about the influence of their behavior on the virtual objects of the media content, which leads to a greatly immersive presentation of the media content and immersive involvement of the viewers into the presented media content. Preferably, said joining includes inserting the removed virtual object into the media content in the respective auxiliary branch. Similar to blending out of further virtual objects from auxiliary branches, said inserting of removed virtual objects may include a blending in of the removed virtual objects, which may include an adaptation of opacity and/or an adjustment of a position and orientation of the removed virtual objects. However, any other technique suitable for seamless insertion of virtual objects may be applied.

According to another aspect of the present disclosure an apparatus is provided.

The apparatus comprises at least one output device for rendering media content including a plurality of virtual objects and a plurality of triggers, each of said plurality of triggers being associated with at least one virtual object of the plurality of virtual objects. The apparatus further comprises a tracking device for tracking a plurality of users of the apparatus, and a controller configured to continuously receive, from the tracking device, tracking data of the plurality of users; match the tracking data to the plurality of triggers; if the tracking data matches at least one trigger, branch the media content into a plurality of branches including a main branch and at least one auxiliary branch, each auxiliary branch associated with at least one user; for each matched trigger, automatically adjust the at least one virtual object associated with the matched trigger in the associated auxiliary branch; simultaneously present the plurality of branches of the media content to respective users of the plurality of users; and join the at least one auxiliary branch with the main branch.

In an embodiment, the tracking device is configured to track a position and orientation related to the plurality of users.

In yet another embodiment, the tracking device is configured to track a viewing direction of at least one user or the user's gaze.

According to one embodiment, the apparatus further comprises a media interface configured to receive the media content. The media interface may be, for example, a communication interface or an I/O interface enabling input of the media content for presentation on the apparatus.

In an embodiment, the apparatus is a consumer device, such as a portable electronic device, which may include capabilities of presenting media content in an immersive way. For example, the apparatus may correspond to a computing or media device and may be connected with a tracking device for tracking the plurality of users and respective output devices, such as one or more stereoscopic displays, an array of loudspeakers and/or force feedback devices for presentation of the media content in one or more modalities to a plurality of users. Preferably, the at least one output device includes a plurality of headsets. Each headset may be provided with a tracker for tracking the gaze of the corresponding user.

According to yet another aspect, a system including an apparatus according to one embodiment of the present disclosure is provided. The system comprises at least one server device, which may be configured to provide or stream the media content. The server device may include at least one rendering engine and may be further configured to receive tracking data from the apparatus. The server device may receive the tracking data and may directly control the media content on the server device and only provide the apparatus with a final rendering of the plurality of branches of the media content according to the tracking data and matched triggers, such as by streaming one or more media streams to the apparatus, each media stream corresponding to a branch.

According to yet another aspect, a computer-readable medium is provided, which can be a tangible computer-readable medium, that may store instructions thereon, which, when installed and/or executed on a computing device, cause a computing device to perform a method according to one or more embodiments of the present disclosure. The computing device may be a media apparatus according to one embodiment of the present disclosure.

Devices according to embodiments of the present disclosure may be implemented in hardware including one or more processors and memory for storing instructions and data that may be processed by the one or more processors to control media according to embodiments of the present disclosure. Furthermore, components of the apparatus or device may be implemented as software components or modules, as hardware components or modules or as a combination of both, such as by using dedicated hardware and APIs providing respective data and commands.

### BRIEF DESCRIPTION OF THE DRAWINGS

The specific features, aspects and advantages of the present disclosure will be better understood with regard to the following description and accompanying drawings where:

FIG. 1 shows a flow chart of a method according to one embodiment of the present disclosure;

FIG. 2 illustrates matching of a viewer's gaze to immersive media content according to one embodiment of the present disclosure;

FIG. 3 shows a schematic view of an apparatus according to one embodiment of the present disclosure; and

FIG. 4 shows a timeline of branching and joining of the media content according to an embodiment of the present disclosure.

### DETAILED DESCRIPTION

In the following description, reference is made to the drawings which show by way of illustration various embodiments. Also, various embodiments will be described by referring to several examples. It is to be understood that the embodiments include changes in design and structure without departing from the scope of the claimed subject matter.

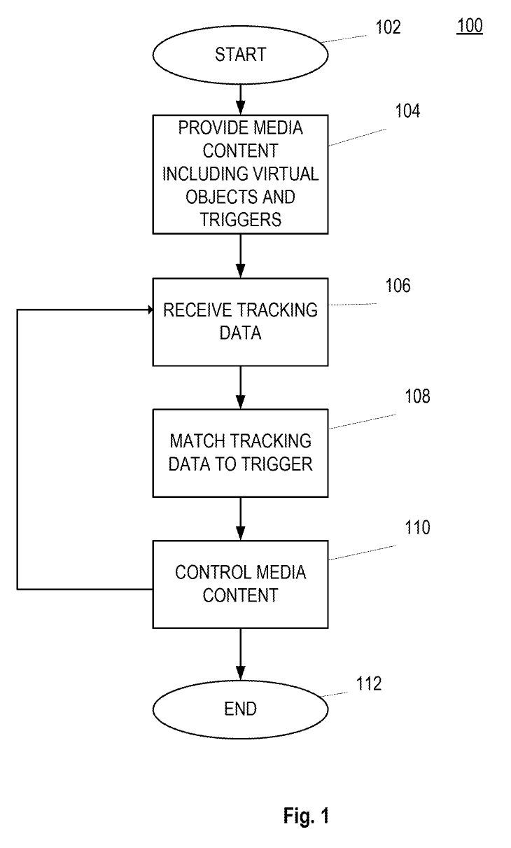

FIG. 1 shows a flow chart of a method according to one embodiment of the present disclosure. The method 100 may be a method for controlling media content.

The method 100 may start in item 102 and proceed with item 104, wherein media content including a plurality of virtual objects and at least one trigger is provided. The at least one trigger may be associated with at least one virtual object of the plurality of virtual objects. The media content may define a single trigger or a plurality of triggers, wherein each trigger may be associated with a different single virtual object or with a plurality of virtual objects. The association of virtual objects may change during progression of the story of the media content. For example, virtual objects may be decoupled from a trigger or associated with a trigger based on progression of the story and/or an implicit interaction with a viewer with the media content.

The method may proceed in item 106, wherein tracking data related to a plurality of viewers of the media content may be received. The tracking data may be matched to the at least one trigger in item 108. The matching 108 may result in a determination whether the tracking data match at least one trigger or not. Alternatively or in addition, the matching may also provide confidence values for individual triggers indicating whether the tracking data match the trigger, for example by indicating a value of 1.0, or whether the tracking data does not match a trigger, which can be indicated by a value of 0.0. Any intermediate value may be used to define a similarity or closeness of the tracking data with regard to a particular trigger. The matching 108 may be performed with regard to each individual trigger and may result in a vector of results. For example, if the immersive media content includes n triggers, the matching for a current portion of tracking data or for a tracking data sample, which may relate to one viewer of the plurality of viewers, may result in a vector M=(m₁, . . . , mₙ), wherein a value m₁ indicates a match of the current portion of tracking data with trigger i. However, it is to be understood that the matching 108 may also include a determination of a most suitable trigger, such as a closest or most similar trigger, and the result of the matching 108 may be a single value and an indication of the most suitable trigger.

The processing may continue in item 110, wherein the immersive media content may be controlled responsive to said matching 108. For example, a determination may be made whether the result of the matching 108 is within a confidence interval or above a certain threshold in order to trigger controlling of the immersive media content for that matched trigger.

The controlling 108 may include, if the tracking data matches at least one trigger, branching the media content into a plurality of branches including a main branch and at least one auxiliary branch, each auxiliary branch associated with at least one viewer and, for each matched trigger, an automatic adjustment of the at least one virtual object associated with the matched trigger in the corresponding auxiliary branch. Based on the results of the matching 108, the associated virtual objects may be determined and automatically adjusted. The matching values may be used as weighting factors in order to automatically adjust the virtual object. For example, the behavior of the virtual objects may be adjusted according to the tracking data. For example, if the tracking data indicates that a viewer is looking at a particular virtual object, behavior of the virtual object may be adjusted according to the tracking data.

The plurality of branches of the media content may be simultaneously presented to respective viewers of the plurality of viewers. For example, each auxiliary branch may be presented to the associated one or more viewers and the main branch may be presented to the remaining viewers, which may be viewers that did not generate tracking data at all or whose tracking data did not match any trigger.

After presentation of the branches to respective viewers, the at least one auxiliary branch may be joined with the main branch and presentation of the main branch may continue. Concurrent to the processing in item 110, the method 100 may proceed with item 106, wherein further tracking data are received and processing in items 108 and 110 may reiterate.

The method 100 may end in item 112, for example after the story of the media content has ended or after a viewer has provided respective input to end presentation of the media content.

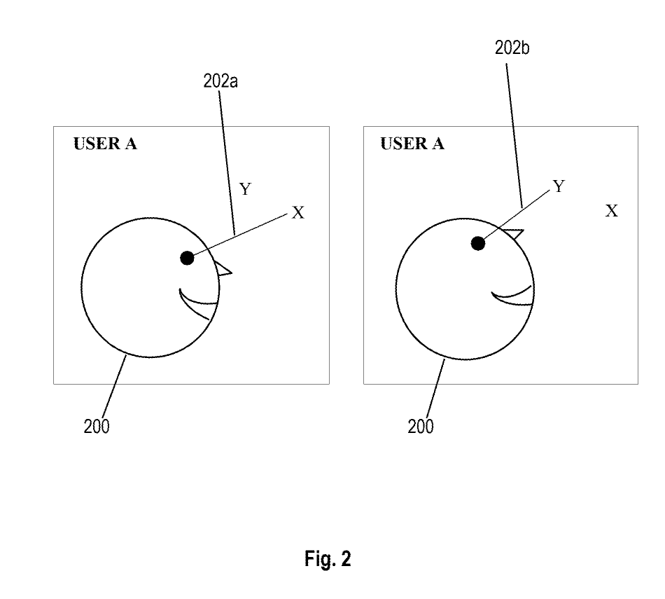

FIG. 2 shows a schematic view of matching of tracking data to triggers of media content according to one embodiment of the present disclosure. A viewer or user 200 may perceive media content in a virtual environment. Based on an orientation of the head of the user 200 or a determination of an orientation of the user's eyes, a viewing direction or gaze 202a, 202b may be determined based on tracking data.

The media content may include a plurality of virtual objects X, Y that may have a position in the virtual environment. Accordingly, based on the user's gaze 202a, 202b, a relation of the user's gaze 202a, 202b to the virtual objects X, Y of the media content may be determined. The user 200 may, for example, look or gaze at the virtual object X or Y, which may determine a further progression of the media content.

For example, in a virtual reality movie, the user 200 may look into the eyes of an actor, which may be represented by the virtual objects X, Y. In response, the actor may move towards user 200. In another example, the user 200 may look at a vehicle in the virtual reality movie, which again may be represented by a different virtual object (not shown). In response, the vehicle may move towards or away from the user 200. Behavior of the virtual objects may be defined by a provider of the media content or may be determined by an engine driving the virtual environment. It is to be understood that many variations are possible in respect to content and behavior of the virtual objects of the media content in relation to tracked behavior, reactions or gaze or viewing direction of the user 200.

Preferably, a gaze analysis may include a determination of head rotation and/or eye tracking and the like, in order to trigger an implicit input and a respective output of the media content.

In yet another example, the tracking data may be continuously monitored in order to calculate a more suitable and stable metric directed at parameters of the user 200. For example, in order to avoid an immediate adjustment of a virtual object based on a temporal gaze of the user 200, the tracking data may be analyzed over time in order to determine a stable indication of a gaze or any other parameter derived from the tracking data. Hence, an initial observation of the media content by a user does not need to lead to an adjustment of all of focused virtual objects associated with respective triggers. Rather, the adjustment may be provided as soon as the user's gaze remains stable with regard to a particular trigger or a respectively associated virtual object for a certain duration.

The at least one trigger of the media content may be explicitly related to individual virtual objects. However, the trigger may be adjusted according to viewing behavior of a viewer that may define hotspots in the media experience. Accordingly, the triggers may be adjusted based on several factors, provided by the media content, the simulated virtual environment as well as the tracking data of the current or previous users, in any combination.

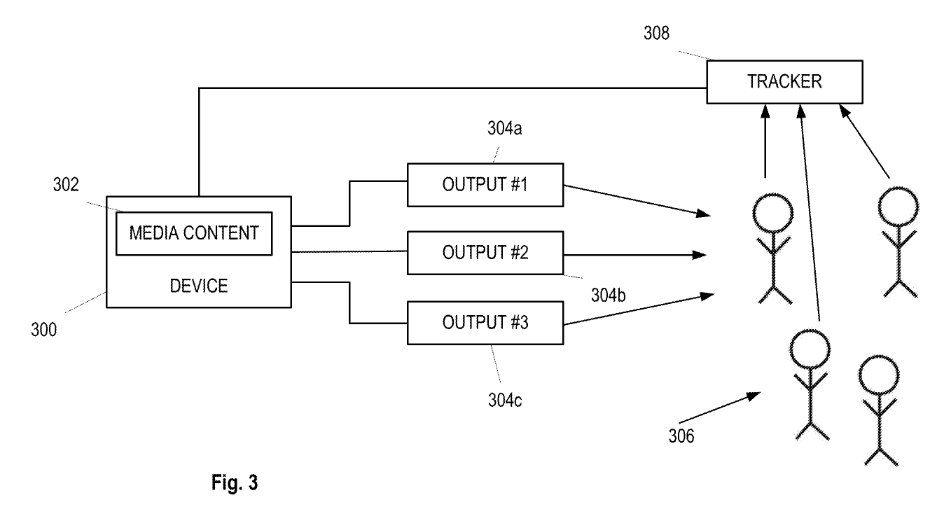

FIG. 3 shows a schematic representation of an apparatus according to one embodiment. The apparatus 300 may be configured to control media content 302 that may be stored within the apparatus 300 or provided as a media stream from a server (not shown).

The apparatus 300 may comprise one or more output devices 304a, 304b, 304c that may provide the media content 302 in respective modalities. For example, output device 304a may render a visual component of the media content 302, output device 304b may render an acoustic component of media content 302, and output device 304c may be a force feedback device. The output devices 304a, 304b, 304c may be operated by a plurality of users 306 and may provide individualized portions of the media content 302 to the users 306 in an immersive way.

The apparatus 300 may further include or may be connected to a tracker 308 which may track behavior of the users 306. For example, the tracker 308 may be an optical or electromagnetic tracker. However, the tracker 308 is not restricted to a particular tracking technology and may relate to any kind of tracker suitable of deriving parameters of at least some of the users 306. Either the tracker 308 or the apparatus 300 may use the obtained sensor data of the tracker 308 to determine parameters related to the user, such as a viewing direction or a gaze of the user or any other spatial, physiological or behavioral data. The sensor data or tracking data may be matched by the apparatus 300 to one or more triggers of the media content 302 in order to determine whether the media content is to be individualized into a plurality of branches for the respective users and whether the tracking data influences one or more virtual objects of the media content 302 in the respective branches in order to provide the individualized portions of the media content 302.

It is to be understood that even though only a single tracker 308 is shown in FIG. 3, the apparatus 300 may include further tracking devices, such as individualized tracking devices for each user. For example, output device 304a may be a head-mounted display which may be equipped with a gaze tracker providing tracking data for the respective user. The individualized tracking data may be combined with the tracking data provided by the tracker 308 and matched to triggers of the media content 302, which may result in respective branching of the media content 302 and adaptation of the virtual objects in the branch for the user. Simultaneously, the other users 306 may be provided with the main branch of the media content or with the same or with another auxiliary branch according to their individualized tracking data. Furthermore, it is to be understood that the tracker 308 may also provide individualized tracking data for each user of the plurality of users 306.

The apparatus 300 may include a processor and memory to store instructions, wherein the processor of the apparatus 300 may be configured to perform a method according to one or more embodiments of the present disclosure. Furthermore, even though three output devices 304a, 304b, 304c and a tracker 308 are shown in FIG. 3, it is to be understood that the apparatus 300 may include more or fewer output devices and/or more tracking devices and the present disclosure is not restricted to a particular number of input and output devices. Furthermore, even though output devices 304a, 304b, 304c have been shown as output devices for individual modalities, it is to be understood that the apparatus 300 may include a plurality of output devices for a single modality, such as two or more output devices for a visual representation of the media content 302.

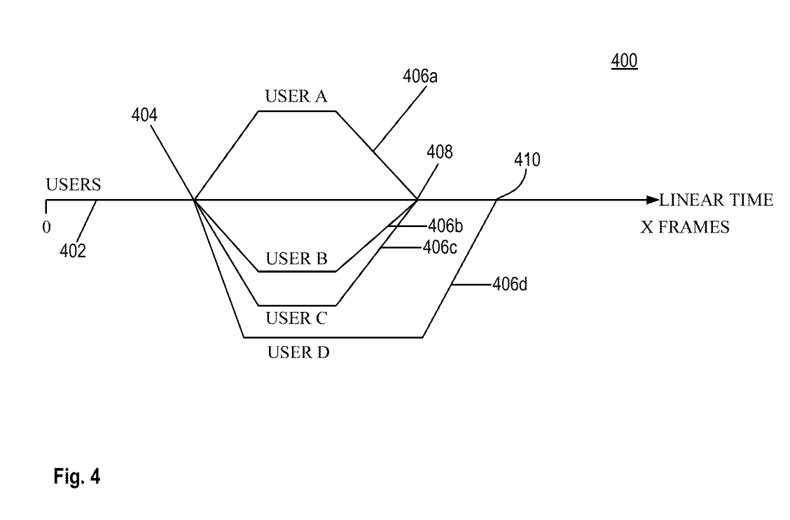

FIG. 4 shows an illustration of a timeline for branching of media content and joining of a plurality of branches according to one embodiment of the present disclosure.

The timeline 400 depicts a presentation of media content, such as frames of the media content, to a plurality of users A, B, C, D. However, it is to be understood that the media content may be presented to any number of users. Initially, a main branch 402 of the media content may be presented to all users. Based on tracking data of the users, a determination may be made that one or more portions of the tracking data matches a trigger of the media content at 404. For example, the tracking data related to user A may match a first trigger, the tracking data related to user B may match a second trigger, the tracking data of user C may match a third trigger, and the tracking data of user D may match a fourth trigger. Subsequently, the media content may be split or branched into four auxiliary branches 406a, 406b, 406c, 406d and, in each branch, virtual objects may be automatically adjusted according to the tracking data and the matched triggers. Splitting at 404 may be followed by a transition period, wherein the virtual objects may be smoothly adjusted in respective branches.

The auxiliary branch 406a may be presented to user A, the auxiliary branch 406b may be presented to user B, the auxiliary branch 406c may be presented to user C and the auxiliary branch 406d may be presented to user D in an individualized way, thereby generating for each user a personalized experience of the media content. For example, the users A, B, C, D may look at different hotspots of the media content, which may correspond respective triggers, which may lead to the branching of the media content at 404.

The auxiliary branches 406a, 406b, 406c, 406d may be again joined with the main branch 402 according to one or more rules or conditions. For example, branches 406a, 406b, 406c may join back with the main branch 402 after a certain duration of time at 408 and users A, B and C may be subsequently provided with the main branch 402 of the media content. However, the auxiliary branches need not be joined back with the main branch 402 at the same point in time. For example, if user D continues to implicitly interact with a trigger of the media content in the respective auxiliary branch 406d, the auxiliary branch 406d may be provided and may be joined back with the main branch 402 at 410 according to the same or other conditions. Thereafter, all users are presented with the main branch 402 of the media content. Through continued evaluation of users, implied non-linear storytelling may be achieved for the plurality of users, which does not disturb a joined and social experience of media content.

While some embodiments have been described in detail, it is to be understood that aspects of the present disclosure can take many forms. The claimed subject matter may be practiced or implemented differently from the examples described and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A method for controlling media, comprising:
providing media content including a plurality of virtual objects and a plurality of triggers, each of said plurality of triggers being associated with at least one virtual object of the plurality of virtual objects;
presenting the media content to a plurality of viewers;
continuously receiving tracking data of the plurality of viewers;
matching the tracking data to the plurality of triggers;
if the tracking data matches at least one trigger, branching the media content into a plurality of branches including a main branch and at least one auxiliary branch, each auxiliary branch associated with at least one viewer;
for each matched trigger, automatically adjusting the at least one virtual object associated with the matched trigger in the corresponding auxiliary branch;
simultaneously presenting the plurality of branches of the media content to respective viewers of the plurality of viewers; and
joining the at least one auxiliary branch with the main branch.

2. The method according to claim 1, further comprising:
determining at least one viewer related to the tracking data matching a trigger;
associating the at least one viewer with a corresponding auxiliary branch; and
simultaneously presenting the associated auxiliary branch to the corresponding at least one viewer.

3. The method according to claim 1, further comprising simultaneously presenting the main branch of the media content to at least some of the remaining viewers.

4. The method according to claim 1, wherein the at least one auxiliary branch is joined with the main branch according to at least one condition.

5. The method according to claim 4, wherein the at least one condition is a time-based condition.

6. The method according to claim 1, said joining including continuously transforming the adjusted at least one virtual object in the at least one auxiliary branch according to corresponding virtual objects in the main branch.

7. The method according to claim 1, said branching including creating one or more instances of at least some of the plurality of virtual objects for each auxiliary branch.

8. The method according to claim 1, said branching including creating one or more references for at least some of the plurality of virtual objects for each auxiliary branch, the references referring to corresponding virtual objects in the main branch.

9. The method according to claim 1, wherein presenting an auxiliary branch includes processing the media content in the auxiliary branch according to one or more instances of virtual objects in the auxiliary branch and one or more references to virtual objects in the main branch.

10. The method according to claim 1, wherein said matching the tracking data to the plurality of triggers includes determining whether, based on the tracking data, a viewing direction of a viewer corresponds to at least one trigger.

11. The method according to claim 10, further including determining whether the viewing direction corresponds to an area associated with at least one trigger, wherein the area is defined based on the at least one virtual object associated with the at least one trigger.

12. The method according to claim 1, wherein at least some of the virtual objects include a set of parameters for determining behavior of the virtual objects in the media content, and the set of parameters is adjusted responsive to said matching.

13. The method according to claim 12, wherein the set of parameters defines a position and orientation of a respective virtual object, wherein the position and orientation of the virtual object is automatically adjusted responsive to said matching.

14. The method according to claim 1, further comprising, for a matched trigger, inserting a further virtual object into the media content in the respective auxiliary branch.

15. The method according to claim 14, wherein said joining includes removing the further virtual object from the media content in the respective auxiliary branch.

16. The method according to claim 1, further comprising, for a matched trigger, removing one of the plurality of virtual objects from the media content in the respective auxiliary branch.

17. The method according to claim 16, wherein said joining includes inserting the removed virtual object into the media content in the respective auxiliary branch.

18. The method according to claim 1, wherein the media content is immersive media content.

19. An apparatus comprising:
at least one output device for rendering media content including a plurality of virtual objects and a plurality of triggers, each of said plurality of triggers being associated with at least one virtual object of the plurality of virtual objects;
a tracking device for tracking a plurality of users of the apparatus; and
a controller configured to:
continuously receive, from the tracking device, tracking data of the plurality of users;
match the tracking data to the plurality of triggers;
if the tracking data matches at least one trigger, branch the media content into a plurality of branches including a main branch and at least one auxiliary branch, each auxiliary branch associated with at least one user;
for each matched trigger, automatically adjust the at least one virtual object associated with the matched trigger in the associated auxiliary branch;
simultaneously present the plurality of branches of the media content to respective users of the plurality of users; and
join the at least one auxiliary branch with the main branch.

20. The apparatus according to claim 19, wherein the tracking device is configured to track at least one position and orientation of the plurality of users.

21. The apparatus according to claim 19, wherein the tracking device is configured to track at least one gaze direction of the plurality of users.

22. The apparatus according to claim 19, wherein the at least one output device includes a plurality of headsets.
